(19) United States
(12) Patent Application Publication
(10) Pub. No.: US 2026/0042383 A1
(43) Pub. Date: Feb. 12, 2026

(54) DEPLOYABLE SEAT FRAME BRACE

(71) Applicant: Ford Global Technologies, LLC, Dearborn, MI (US)

(72) Inventors: Mohammad Omar Faruque, Ann Arbor, MI (US); S.M. Iskander Farooq, Novi, MI (US); Dean M. Jaradi, Macomb, MI (US)

(73) Assignee: Ford Global Technologies, LLC, Dearborn, MI (US)

(21) Appl. No.: 18/795,611

(22) Filed: Aug. 6, 2024

(51) Int. Cl. B60N 2/427; B60R 22/26

(52) U.S. Cl. CPC B60N 2/4279; B60N 2/42727; B60R 22/26

(57) ABSTRACT

A system includes a seat bottom having a seat bottom frame and a seatback having a seatback frame pivotably supported by the seat bottom frame. The system also includes a seat frame brace movable between a stowed configuration and a deployed configuration. The seat frame brace includes a back link having a first end portion and a second end portion coupled to the seatback frame. An actuator is coupled to the seat bottom frame and operative to move the first end portion in a seat rearward direction to position the seat frame brace in the deployed configuration.

### BACKGROUND

A vehicle may include a seat and a seatbelt assembly. The seat can include a seatback and a seat bottom that can support an occupant of the seat. For example, the occupant of the seat may sit on a top surface of the seat bottom and recline against the seatback. The seatbelt assembly may include a seatbelt retractor and webbing retractably payable from the seatbelt retractor, in a controlled manner under certain conditions. The seatbelt assembly may include an anchor coupled to the webbing, and a latch plate that engages a buckle. The seatbelt assembly may be disposed adjacent to a seat of the vehicle. The webbing may extend continuously from the seatbelt retractor to the anchor. For example, one end of the webbing feeds into the seatbelt retractor, and the other end of the webbing is fixed to the anchor. The seat and the seatbelt assembly can work in conjunction to control occupant kinematics in the event of certain vehicle impacts. In some examples, the seatbelt assembly may be a seat integrated restraint (SIR) in which various components of the seatbelt assembly, e.g., the retractor, webbing guide, and/or the anchor, are carried by the seat.

### BRIEF DESCRIPTION OF THE DRAWINGS

FIG. 1A is a side view of a portion of a vehicle including a seat having a deployable seat frame brace in a stowed configuration.

FIG. 1B is a side view of the seat in FIG. 1A with the deployable seat frame brace in a deployed configuration.

FIG. 2 is an enlarged partial side view of the deployable seat frame brace in the stowed configuration.

FIG. 3 is an enlarged partial side view of the deployable seat frame brace in the deployed configuration.

FIG. 4A is a side view of a linear actuator and latch.

FIG. 4B is a top view of the linear actuator and latch shown in FIG. 4A.

FIG. 5 is a block diagram of a system of the vehicle.

### DETAILED DESCRIPTION

A seat system includes a seat bottom having a seat bottom frame and a seatback having a seatback frame pivotably supported by the seat bottom frame. A seat frame brace is movable between a stowed configuration and a deployed configuration. The seat frame brace includes a back link having a first end portion and a second end portion coupled to the seatback frame. An actuator is coupled to the seat bottom frame and operative to move the first end portion in a seat rearward direction to position the seat frame brace in the deployed configuration.

The actuator can be a linear actuator positioned to extend in the seat rearward direction when actuated.

The linear actuator can be retracted in the stowed configuration and extended in the deployed configuration.

The linear actuator can be fixed to the seat bottom frame.

The first end portion of the back link can be pivotably and slidingly coupled to the linear actuator.

The system can include a latch operative to lock the back link and the actuator in position upon reaching the deployed configuration.

The actuator can include a channel fixed to the seat bottom frame, a bar slidably disposed in the channel and coupled to the first end portion, and a cylinder carried by the bar and positioned to extend the bar in the seat rearward direction when actuated.

The system can include a latch positioned to extend into the channel to lock the bar and the back link in position upon reaching the deployed configuration.

The system can include a webbing guide mounted on the seatback frame.

The seat frame brace can be coupled to the seatback frame on a same side of the seatback frame as the webbing guide.

The system can include a second seat frame brace coupled to an opposite side of the seatback frame as the webbing guide.

The system can include a seatbelt assembly supported by the seatback frame.

An anchor of the seatbelt assembly can be positioned between the seat bottom frame and the seat frame brace.

The first end portion can be positioned seat rearward of a seatback pivot axis when the seat frame brace is in the deployed configuration.

The system can include a processor and a memory device storing instructions executable by the processor to activate the actuator in response to certain vehicle impacts in order to move the seat frame brace to the deployed configuration and resist forward movement of the seatback relative to the seat bottom.

The actuator can be a pyrotechnic device.

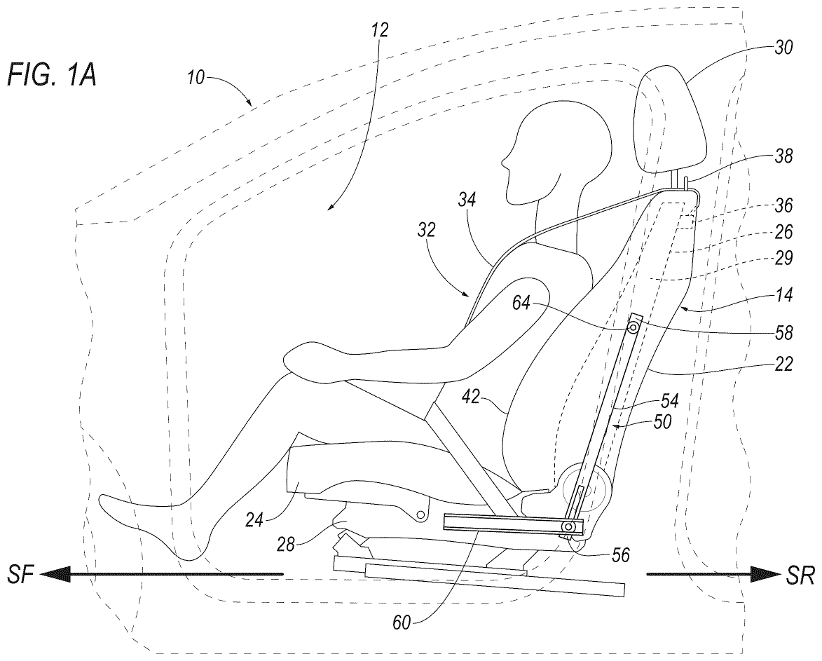

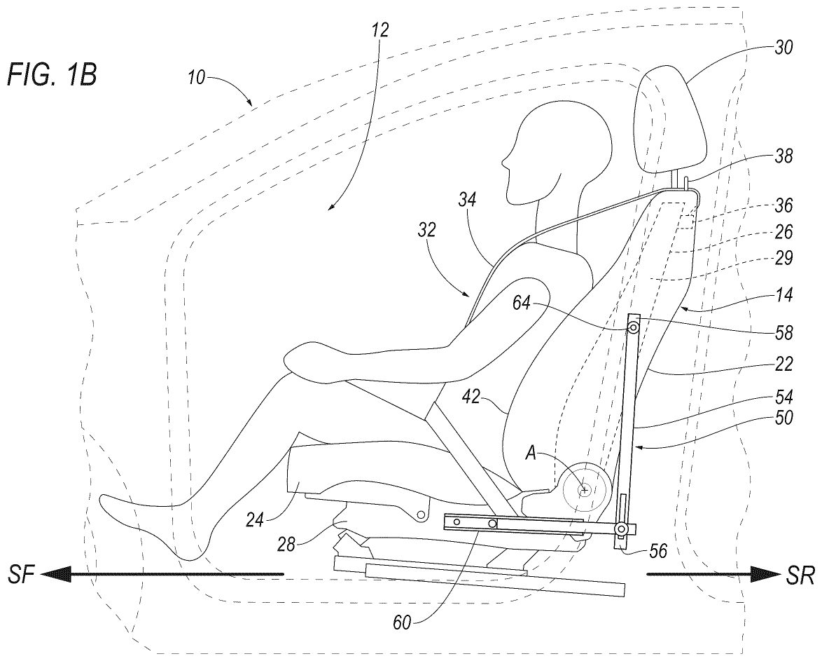

With reference to the Figures, where like numerals indicate like features throughout the several views, an example of a seat system having a deployable seat frame brace 50 can include a seat assembly 14 with a seat bottom 24 having a seat bottom frame 28 and a seatback 22 having a seatback frame 26 pivotably supported by the seat bottom frame 28. The seat frame brace 50 is movable between a stowed configuration (FIG. 1A) and a deployed configuration (FIG. 1B). The seat frame brace includes a back link 54 having a first end portion 56 coupled to an actuator 60 and a second end portion 58 coupled to the seatback frame 26. The seat frame brace 50 also includes the actuator 60 coupled to the seat bottom frame 28 and operative to move the first end portion 56 in a seat rearward direction SR to position the seat frame brace 50 in the deployed configuration, thereby resisting movement of the seatback 22 in a seat forward direction SF.

With reference to FIG. 1A, the vehicle 10 may be any suitable type of ground vehicle, e.g., a passenger or commercial automobile such as a sedan, a coupe, a truck, a sport utility, a crossover, a van, a minivan, a taxi, a bus, etc. The vehicle 10 may define a passenger cabin 12 to house occupants, if any, of the vehicle 10. The passenger cabin 12 may extend across the vehicle 10, e.g., from a left side of the vehicle 10 to a right side of the vehicle 10. The passenger cabin 12 includes a front end and a rear end with the front end being in front of the rear end during forward movement of the vehicle 10.

One or more seats, such as seat 14, may be supported in the passenger cabin 12, e.g., by a floor of the vehicle 10. Each seat 14 includes a seatback 22 and a seat bottom 24 that can support the occupant of the seat 14. For example, the occupant of the seat 14 may sit atop a top surface of the seat bottom 24 and recline against the seatback 22. While seat 14 shown in the Figures is in the front driver position, the disclosed technology can be applied to any seat in the vehicle.

The seatback 22 may include a seatback frame 26. The seatback frame 26 may include tubes, beams, etc. Specifically, the seatback frame 26 may include a pair of upright frame members 29. The upright frame members 29 are elongated, and specifically, are elongated in a generally upright direction (e.g., along a seat-vertical axis) when the seatback 22 is in a generally upright position. The upright frame members 29 are spaced apart from each other in a cross-vehicle direction. The seatback frame 26 may include one or more cross-members extending between the upright frame members 29.

The seat bottom 24 has a front end and a rear end. The front end is seat-forward of the rear end in the seat forward direction SF. The seat bottom 24 can include a seat bottom frame 28. The frame 28 may include tubes, beams, etc. Specifically, the seat bottom frame 28 may include a pair of frame members elongated in the seat-forward direction, e.g., between the front end and the rear end of the seat bottom 24. The seat bottom frame 28 may include cross-members extending between the frame members. The seat bottom frame 28 can include a seat pan. The seat pan may be generally planar and extend from one of the frame members to the other of the frame members. The seat pan may be fixed to the frame members.

The seatback frame 26 and the seat bottom frame 28 may be of any suitable plastic material, e.g., carbon fiber reinforced plastic (CFRP), glass fiber-reinforced semi-finished thermoplastic composite (organosheet), etc. As another example, some or all components of the seatback frame 26 and the seat bottom frame 28 may be formed of a suitable metal, e.g., steel, aluminum, etc. The seatback 22 and the seat bottom 24 can include suitable covers. The covers may include upholstery and padding. The upholstery may be cloth, leather, faux leather, or any other suitable material. The upholstery may be stitched in panels around the frames. The padding may be between the upholstery and the frames. The padding may be foam or any other suitable material.

The seatback 22 is supported by the seat bottom 24 at the rear end. The seat bottom 24 extends from the seatback 22 in the seat-forward direction SF of the seat 14. The rear end is proximate to the seatback 22 and the front end is distal from the seatback 22. The seatback 22 may be stationary or movable relative to the seat bottom 24. In an example, the seatback 22 is pivotably supported by the seat bottom 24 and may be selectively pivotable to a desired position by an occupant of the seat 14. In such an example, the seatback 22 is pivotable with respect to the seat bottom 24 about a pivot axis A (FIG. 1B). The seatback 22 and the seat bottom 24 may be adjustable in multiple degrees of freedom. Specifically, the seatback 22 and the seat bottom 24 may themselves be adjustable, in other words, adjustable components within the seatback 22 and/or the seat bottom 24, and/or may be adjustable relative to each other. The seatback 22 may be selectively pivotable about the pivot axis A and selectively locked in position relative to the pivot axis A with any suitable mechanism, including mechanical and/or electronic components, and in some examples, including currently known mechanisms.

The seat 14 may include a head restraint 30. The head restraint 30 may be supported by the seatback 22. The head restraint 30 may be at a top end of the seatback 22. The head restraint 30 may be stationary or movable relative to the seatback 22. The seatback 22 and the head restraint 30 may be adjustable in multiple degrees of freedom. Specifically, the seatback 22 and/or the head restraint 30 may themselves be adjustable and/or may be adjustable relative to each other. Operations, systems, and methods described herein should always be implemented and/or performed in accordance with an applicable owner's/user's manual and/or safety guidelines.

A seatbelt assembly 32 is associated with each seat 14. The seatbelt assembly 32 can include a retractor 36 and a webbing 34. The webbing 34 is retractably payable from the retractor 36. The seatbelt assembly 32 may include an anchor (not visible) fixed to the webbing 34 and a latch plate (not visible) that engages a buckle (not visible). The webbing 34 may extend continuously from the retractor 36 through a webbing guide 38 and to the anchor. The latch plate may slide freely along the webbing 34, and when engaged with the buckle, divide the webbing 34 into a lap belt and a shoulder belt. The webbing 34 may be fabric, e.g., polyester.

The seatbelt assembly 32 may be a seat-integrated restraint (SIR) in which various components of the seatbelt assembly 32, e.g., the retractor 36 and the webbing guide 38, are carried by the seatback frame 26. For example, the frame of the retractor 36 may be fixed to the frame 26 of the seatback 22 via weld, fastener, or other suitable structure. The retractor 36 may be supported by the seatback 22 at the top end as shown. It is contemplated that future regulatory and technology evolution may allow for safe and permissible use of seats that are selectively rotatable to different facing positions, and in such examples, the seatbelt assembly 32 may be a SIR.

As a result of certain vehicle impacts, the occupant can pull against the webbing 34, which is attached to the seatback 22, via the webbing guide 38 and the retractor 36, applying forces to the seatback 22 that tend to pivot and/or twist the seatback 22 in a seat-forward direction with respect to the seat bottom 24. In response to certain vehicle impacts the seat frame brace 50 moves from the stowed configuration to the deployed configuration, thereby resisting movement of the seatback 22 in the seat-forward direction. In an example, the seat frame brace 50 can be mounted to the seat frames 26 and 28 on the same side of the seat 14 as the webbing guide 38. In some examples, seat frame braces 50 can be mounted to both sides of the seat frames 26 and 28. In other words, a second seat frame brace 50 can be coupled to the seatback frame 26 and the seat bottom frame 28 on an opposite side of the seat frames 26 and 28 as the webbing guide 38.

With reference to FIG. 1B, the seat frame brace 50 is movable between the stowed configuration (FIG. 1A) and a deployed configuration (FIG. 1B). The seat frame brace 50 includes a back link 54 having a first end portion 56 and a second end portion 58. The second end portion 58 can be coupled to the seatback frame 26. The second end portion 58 of the back link 54 can be pivotably mounted to the upright frame member 29 with any suitable hardware, such as shoulder screw 64. The seat frame brace 50 also includes an actuator 60 coupled to the seat bottom frame 28 and operative to move the first end portion 56 in a seat rearward direction SR to position the seat frame brace 50 in the deployed configuration, thereby resisting movement of the seatback 22 in a seat forward direction SF. In an example, the seat frame brace 50, i.e., actuator 60 and back link 54, can have a tensile and/or bending strength greater than the forces against the seatback 22 that are expected in certain vehicle impacts. The first end portion 56 is positioned seat rearward of the seatback pivot axis A when the seat frame brace 50 is in in the deployed configuration. Positioning the first end portion 56 rearward of the seatback pivot axis A increases the strength of the seat frame brace relative to forward motion of the seatback 22.

The seat frame brace 50 may be concealed by a covering 42, e.g., the upholstery of the seat bottom 24 and the seatback 22. In other words, the seat frame brace 50 may be between the frames 26 and 28 of the seat 14 and the upholstery of the seat 14. The covering 42 may include a tear seam (not numbered) associated with the seat frame brace 50. The seat frame brace 50 may extend through the tear seam as it is deployed. The tear seam may be designed to tear apart when subjected to a tensile force above a threshold magnitude. In other words, the covering 42 on one side of the tear seam separates from the covering 42 on the other side of the tear seam when the force is above the threshold magnitude. The threshold magnitude may be chosen to be greater than forces from, e.g., inadvertent pushing against the seat by an occupant but be less than forces from the deployment of the seat frame brace 50. The tear seam may be, for example, a line of perforations through the covering 42, a line of thinner covering material than the rest of the covering 42, etc.

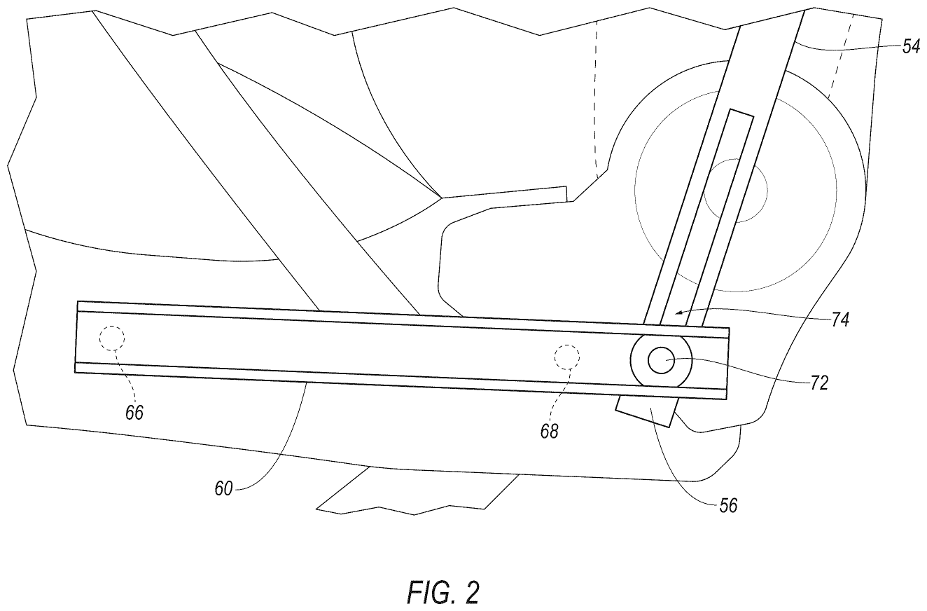

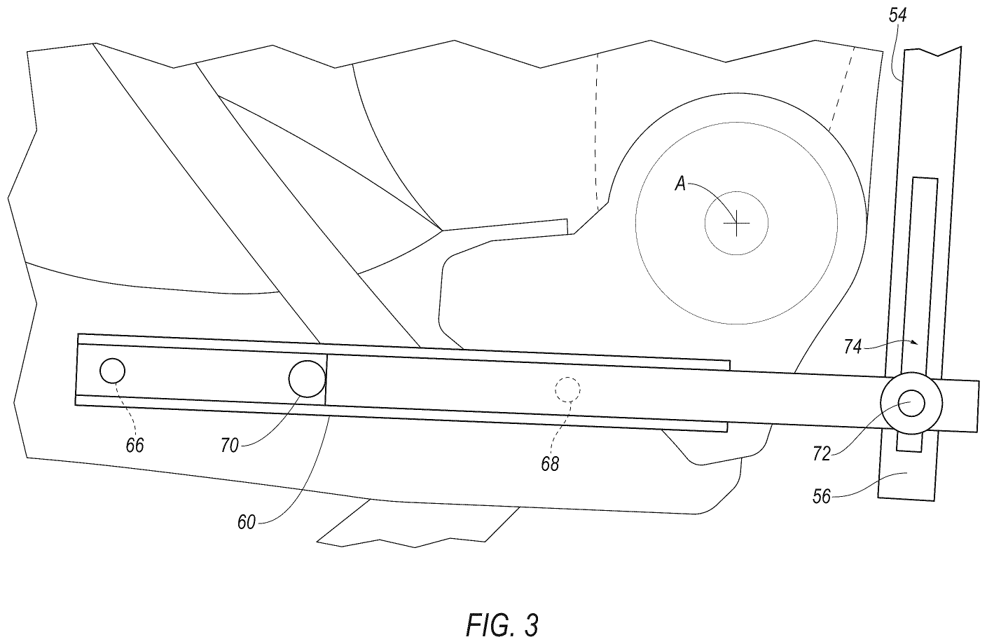

As shown in FIG. 2, the actuator 60 can be fixed to the seat bottom frame 28 via weld, fastener (such as bolts 66 and 68), or other suitable structure. The actuator 60 is retracted in the stowed configuration as shown in FIG. 2 and extended in the deployed configuration as shown in FIG. 3. The first end portion 56 of the back link 54 is pivotably and slidingly coupled to the actuator 60. For example, suitable hardware, such as a nut and bolt arrangement 72, can couple the actuator 60 to a slot 74 formed in back link 54. As the seatback 22 is pivoted forward or backward (i.e., reclined) with respect to the seat bottom 24, the back link 54 can rotate about nut and bolt arrangement 72 and if necessary, slide along slot 74 with respect to the actuator 60.

With reference to FIG. 3, in an example, the actuator 60 is a linear actuator positioned to extend in the seat rearward direction when actuated. The first end portion 56 is positioned seat rearward of the seatback pivot axis A when the seat frame brace 50 is in in the deployed configuration. Positioning the first end portion 56 rearward of the seatback pivot axis A increases the strength of the seat frame brace relative to forward motion of the seatback 22. The actuator 60 can be a solenoid device, a pyrotechnic device, pneumatic device, hydraulic device, or other suitable actuator. The seat brace can include a latch 70 operative to lock the back link 54 and the actuator 60 in position upon reaching the deployed configuration.

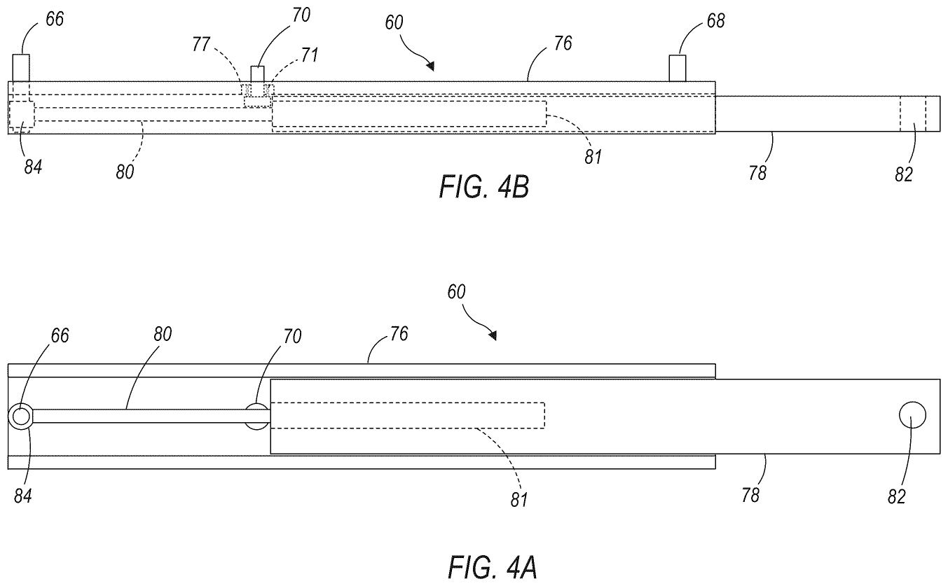

With reference to FIGS. 4A and 4B, the actuator 60 can be a linear actuator including a channel 76 fixed to the seat bottom frame 28 with e.g., the bolts 66 and 68. A bar 78 is slidably disposed in the channel 76 and coupled to the first end portion 56 with the nut and bolt arrangement 72 (FIG. 3). The nut and bolt arrangement 72 can extend through the slot 74 and an aperture 82 that is formed through the bar 78 thereby pivotably and slidingly coupling the bar 78 with the first end portion 56 of the back link 54.

In an example, a cylinder 80 is carried by the bar 78 and positioned to extend the bar 78 in the seat rearward direction when actuated. The cylinder 80 can have a cylindrical shaped cylinder portion 81 that is secured inside the bar 78. The bar 78 can have a rectangular shape to facilitate sliding engagement with the channel 76. A rod end 84 of the cylinder 80 can be attached to the channel 76 and/or seat bottom frame 28 with the fastener 66, for example. As noted above, the cylinder 80 can be a solenoid device, a pyrotechnic device, pneumatic device, hydraulic device, or other suitable actuator.

In an example, the latch 70 can be in the form of a pin that is positioned in a pocket 77 (e.g., a counter-bore) formed in the channel 76. The latch pin 70 can be biased against the bar 78 with a resilient member, such as compression spring 71. When actuated, the bar 78 can slide in the channel 76 in the seat rearward direction SR and once the bar 78 moves past the latch pin 70, the latch pin extends into the channel 76 to lock the bar 78 and back link 54 in position upon reaching the deployed configuration. Specifically, the latch prevents axial sliding between the actuator bar 78 and the channel 76 to lock the bar 78, the actuator 60, and the back link 54 in the deployed configuration after the bar 78 and the back link 54 move from the stowed configuration to the deployed configuration.

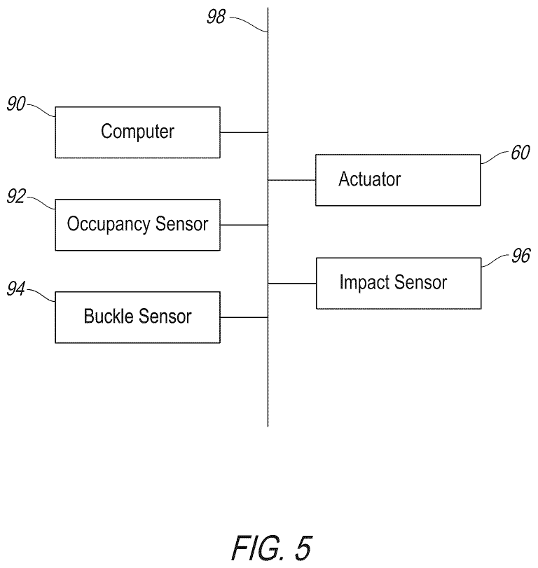

With reference to FIG. 5, the system can include the seat assembly 14 and the deployable seat frame brace 50, as well as a computer 90, a network 98, and various sensors, including an occupancy sensor 92, a buckle sensor 94, and an impact sensor 96. The vehicle 10 may include an occupancy sensor 92 configured to detect occupancy of the seat 14. The occupancy sensor 92 may include visible-light or infrared cameras directed at the seat, weight sensors supported by the seat bottom 24, or other suitable structure, including those conventionally known. The occupancy sensor 92 provides data to the computer 90 indicating whether the seat 14 is occupied or unoccupied.

The vehicle 10 may include a buckle sensor 94 that detects engagement of the latch plate of the seatbelt assembly 32 with the buckle. The buckle sensor 94 may include a switch, a contact sensor, a hall effect sensor, or any other suitable structure for detecting engagement of the latch plate with the buckle, including conventional structures. The buckle sensor 94 provides data to the computer 90 indicating whether the latch plate is engaged with, or disengaged from, the buckle.

The vehicle 10 may include at least one impact sensor 96 for sensing certain vehicle impacts (e.g., impacts of a certain magnitude, direction, etc.). The vehicle computer 90 may activate the actuator 60, e.g., provide power to a solenoid or an impulse to a pyrotechnic charge, when the impact sensor 96 senses certain vehicle impacts. Alternatively or additionally to sensing certain vehicle impacts, the impact sensor 96 may be configured to sense certain vehicle impacts prior to impact, i.e., pre-impact sensing.

The impact sensor 96 is configured to detect certain vehicle impacts. In other words, a “certain vehicle impact” is an impact of the type and/or magnitude for which activation of the seat frame brace 50 is designed i.e., “certain” indicates the type and/or magnitude of the impact. The type and/or magnitude of such “certain vehicle impacts” may be pre-stored in the computer 90, e.g., a restraints control module and/or a body control module. The impact sensor 96 may be of any suitable type, for example, post contact sensors such as accelerometers, pressure sensors, and contact switches; and pre-impact sensors such as radar, LIDAR, and vision sensing systems. The vision sensing systems may include one or more cameras, CCD image sensors, CMOS image sensors, etc. The impact sensor 96 may be located at numerous points in or on the vehicle 10.

The vehicle 10 may include a communication network 98. The communication network 98 includes hardware, such as a communication bus, for facilitating communication among vehicle components, e.g., the computer 90, the occupancy sensor 92, the buckle sensor 94, the impact sensor 96, the actuators 60, etc. The communication network 98 may facilitate wired or wireless communication among the vehicle components in accordance with a number of communication protocols such as controller area network (CAN), Ethernet, Wi-Fi, Local Interconnect Network (LIN), and/or other wired or wireless mechanisms. Alternatively or additionally, in cases where the computer 90 comprises a plurality of devices, the communication network 98 may be used for communications between devices represented as the computer 90 in this disclosure.

The computer 90 may be a microprocessor-based computer implemented via circuits, chips, or other electronic components. The computer 90 includes a processor, a memory device, etc. The memory of the computer 90 may include memory for storing programming instructions executable by the processor as well as for electronically storing data and/or databases. For example, the computer 90 can be a generic computer with a processor and memory as described above and/or may include an electronic control unit (ECU) or controller for a specific function or set of functions, and/or a dedicated electronic circuit including an ASIC that is manufactured for a particular operation, e.g., an ASIC for processing sensor data and/or communicating the sensor data. As another example, the computer 90 may be a restraints control module. In another example, computer 90 may include an FPGA (Field-Programmable Gate Array) which is an integrated circuit manufactured to be configurable by a user. Typically, a hardware description language such as VHDL (Very High-Speed Integrated Circuit Hardware Description Language) is used in electronic design to describe digital and mixed-signal systems such as FPGA and ASIC. For example, an ASIC is manufactured on VHDL programming provided pre-manufacturing, whereas logical components inside an FPGA may be configured based on VHDL programming, e.g., stored in a memory electrically connected to the FPGA circuit. In some examples, a combination of processor(s), ASIC(s), and/or FPGA circuits may be included in the computer 90. The memory can be of any type, e.g., hard disk drives, solid state drives, servers, or any volatile or non-volatile media. The memory can store the collected data sent from the sensors.

The computer 90 is programmed to, i.e., the memory stores instructions executable by the processor to, command the actuator 60 to e.g., move the first end portion 56 in a seat rearward direction SR to position the seat frame brace 50 in the deployed configuration. The computer 90 may deploy the seat frame brace 50 by providing power to a solenoid, an impulse to a pyrotechnic charge, or actuating a fluid control valve via the communication network 98. The computer 90 may be programmed to deploy the seat frame brace 50 in response to detecting certain vehicle impacts. The computer 90 may determine that a certain vehicle impact has occurred or may occur based on information received from the impact sensor 96 via the communication network 98.

The computer 90 may determine that the seat 14 is occupied based on information received from the occupancy sensor 92 via the communication network 98. In an example, the computer 90 may be programmed to deploy the seat frame brace 50 in response to detecting certain vehicle impacts and when the computer 90 has determined that the seat 14 is occupied.

The computer 90 may determine that the latch plate of the seatbelt assembly 32 is engaged with the buckle based on information received from the buckle sensor 94 via the communication network 98. In an example, the computer 90 may be programmed to deploy the seat frame brace 50 in response to detecting certain vehicle impacts and when the computer 90 has determined that the latch plate is engaged with the buckle.

The computer 90 may determine that the seat 14 is occupied and that the latch plate of the seatbelt assembly 32 is engaged with the buckle. In another example, the computer 90 may be programmed to deploy the seat frame brace 50 in response to detecting certain vehicle impacts and when the computer 90 has determined that the seat 14 is occupied and the latch plate is engaged with the buckle.

Computing devices, such as the computer 90, generally include computer-executable instructions, where the instructions may be executable by one or more computing devices such as those listed above. Computer-executable instructions may be compiled or interpreted from computer programs created using a variety of programming languages and/or technologies. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory.

The adverb “approximately” modifying a value or result means that a shape, structure, measurement, value, determination, calculation, etc. may deviate from an exactly described geometry, distance, measurement, value, determination, calculation, etc., because of imperfections in materials, machining, manufacturing, sensor measurements, computations, processing time, communications time, etc.

The numerical adjectives first, second, etc., are used throughout this document as identifiers and do not signify importance, order, or quantity.

Use of in “response to,” “based on,” and “upon determining” herein indicates a causal relationship, not merely a temporal relationship.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A system, comprising:
a seat bottom having a seat bottom frame and a seatback having a seatback frame pivotably supported by the seat bottom frame; and
a seat frame brace movable between a stowed configuration and a deployed configuration, the seat frame brace including:
a back link having a first end portion and a second end portion coupled to the seatback frame; and
an actuator coupled to the seat bottom frame and operative to move the first end portion in a seat rearward direction to position the seat frame brace in the deployed configuration.

2. The system of claim 1, wherein the actuator is a linear actuator positioned to extend in the seat rearward direction when actuated.

3. The system of claim 2, wherein the linear actuator is retracted in the stowed configuration and extended in the deployed configuration.

4. The system of claim 2, wherein the linear actuator is fixed to the seat bottom frame.

5. The system of claim 4, wherein the first end portion of the back link is pivotably and slidingly coupled to the linear actuator.

6. The system of claim 1, further comprising a latch operative to lock the back link and the actuator in position upon reaching the deployed configuration.

7. The system of claim 1, wherein the actuator includes a channel fixed to the seat bottom frame; a bar slidably disposed in the channel and coupled to the first end portion; and a cylinder carried by the bar and positioned to extend the bar in the seat rearward direction when actuated.

8. The system of claim 7, further comprising a latch positioned to extend into the channel to lock the bar and the back link in position upon reaching the deployed configuration.

9. The system of claim 1, further comprising a webbing guide mounted on the seatback frame.

10. The system of claim 9, wherein the seat frame brace is coupled to the seatback frame on a same side of the seatback frame as the webbing guide.

11. The system of claim 10, further comprising a second seat frame brace coupled to an opposite side of the seatback frame as the webbing guide.

12. The system of claim 1, further comprising a seatbelt assembly supported by the seatback frame.

13. The system of claim 12, wherein an anchor of the seatbelt assembly is positioned between the seat bottom frame and the seat frame brace.

14. The system of claim 1, wherein the first end portion is positioned seat rearward of a seatback pivot axis when the seat frame brace is in the deployed configuration.

15. The system of claim 1, further comprising a processor and a memory device storing instructions executable by the processor to activate the actuator in response to certain vehicle impacts in order to move the seat frame brace to the deployed configuration and resist forward movement of the seatback relative to the seat bottom.

16. The system of claim 15, wherein the actuator includes a channel fixed to the seat bottom frame; a bar slidably disposed in the channel and coupled to the first end portion; and a cylinder carried by the bar and positioned to extend the bar in the seat rearward direction when actuated.

17. The system of claim 16, further comprising a latch positioned to extend into the channel to lock the bar and the back link in position upon reaching the deployed configuration.

18. The system of claim 15, further comprising a latch operative to lock the back link and the actuator in position upon reaching the deployed configuration.

19. The system of claim 15, wherein the actuator is a pyrotechnic device.

20. The system of claim 15, wherein the first end portion of the back link is pivotably and slidingly coupled to the actuator.
